(19) United States
(12) Patent Application Publication
(10) Pub. No.: US 2018/0293676 A1
(43) Pub. Date: Oct. 11, 2018

(54) REAL ESTATE PRICE AND ACTIVITY INDICES

(71) Applicant: Shi Cun Xie, Vancouver (CA)

(72) Inventor: Shi Cun Xie, Vancouver (CA)

(21) Appl. No.: 15/950,030

(22) Filed: Apr. 10, 2018

Related U.S. Application Data
(60) Provisional application No. 62/483,870, filed on Apr. 10, 2017.

(51) Int. Cl. G06Q 50/16; G06F 17/30

(52) U.S. Cl. CPC G06Q 50/163; G06F 17/30946

(57) ABSTRACT

The present invention relates to real estate indices for price and activity of real estate sales by applying a quantitative methodology in direct calculations based on limited variables of sales data including sold prices, sold dates, numbers of sales and volumes of sales. The index can be reported monthly, weekly or daily when the relevant data are available.

### FIELD OF THE INVENTION

The present invention relates to real estate and more specifically to quantitative methodology for determining a real estate price index and a real estate activity index.

### BACKGROUND OF THE INVENTION

Canadian patent application 2,760,827 for a “System for Generating a Housing Price Index” describes a computer system for automated generation of a housing price index in which the system can receive transaction data relating to the sale of a Real Estate or apartment and generate a hedonic price index based on the received transaction data for a specified period. The system can further be configured to continuously determine an estimate of the price index for the current period based on received new transaction data. The housing price index can be disseminated in real time, the method and system as described herein significantly reduces the risk for market manipulation and insider trading in a financial instrument relying on a housing price index. This is obtained by continuously generating an estimate of the index as deal data is generated an input into the system.

U.S. Pat. No. 9,607,310 for a “System, method and computer program for forecasting residual values of a durable good over time” describes forecasting future values of real estate and provides a methodology for forecasting residual values of real estate in two time periods and determining changes in value in a valuation metric. By estimating the changes in value for successive future time intervals, a function can be constructed to capture the estimated relationship between time and the item's value. Implementing the methodology, embodiments provide a model which can predict the residual value of real estate at a future time point for any time period. The current market value of real estate at the beginning of an estimation period is known and can be used as a baseline against which future values are computed. The farther away in time a forecast is relative to the baseline, the more uncertainty will exist. Thus, the forecasting error will grow as the width of the time interval increases. Taking this uncertainty into consideration, embodiments utilize different types of variables to aid in forecasting residual values of real estate over time. Example types of forecasting variables include, but are not limited to, modifications to the real estate, locality of the real estate, depreciation of the real estate, microeconomic factors, macroeconomic factors, and sets of competitive real estate.

Current real estate indices use modeling requiring inputs of a significant number of variables and assumptions, for example, linear regression modeling applying many variables in the equations. Current real estate indices use complicated models requiring many variables and assumptions for inputs rather than the application of quantitative methodologies.

### SUMMARY OF THE INVENTION

In an embodiment of the present invention, there is provided a method for automated generation of a real estate price index, for a specified period of time using a computer system having a server computer coupled to a network and a local data storage device coupled to the server computer, wherein the server computer is configured to receive and store from external sources real estate sales prices of individual properties, within selected criteria and in a specific geographical area,

wherein a price weighted annualized price growth rate is calculated based on the annualized price growth rate multiplied by an individual property price divided by the sum of the sold prices,
wherein an aggregated price weighted annualized price growth rate is calculated for a beginning of the specified period of time based on the price weighted annualized price growth rate of all the individual properties,
wherein an aggregated price weighted annualized price growth rate is calculated for an end of the specified period of time based on the price weighted annualized price growth rate of all the individual properties,
and wherein the real estate price index is the ratio of the aggregated price weighted annualized price growth rate from the beginning of the specified period of time to the aggregated price weighted annualized price growth rate from the end of the specified period of time.

In an embodiment of the present invention, there is provided a method for automated generation of a real estate active index, for a specified period of time using a computer system having a server computer coupled to a network and a local data storage device coupled to the server computer, wherein the server computer is configured to receive and store from external sources real estate sales prices of individual properties, within selected criteria and in a specific geographical area,

wherein the sum of the sale prices for all the individual properties is calculated at the beginning of the specified period of time and at the end of the specified period of time;
and the Golden Ratio is applied to combine the number of properties at the beginning and the end of the specified period of time with the sum of the sale prices at the beginning and the end of the specified period of time adjusted by the number of business days.

In an embodiment of the present invention, there is provided a method for automated generation of a real estate price index, HPI, for a specified period of time using a computer system having a server computer coupled to a network and a local data storage device coupled to the server computer, wherein the server computer is configured to receive and store from external sources real estate sales prices of individual properties, n, within selected criteria and in a specific geographical area, wherein X is the real estate sales price in the specified period of time at date A and Y is the previous real estate sales price at date B, and the APGR and weighted APGR for each individual property is determined as follows:

Step 1: Calculating the Annualized Price Growth Rate, called gᵢ:

$${g}_{i} = {( \frac{{X}_{i}}{{Y}_{i}} )}^{\frac{365}{{A}_{i} - {B}_{i}}} - 1$$

Step 2: Calculating the sum of the sold prices for all above n properties, called V.

$$V = {\sum }_{i = 1}^{n} {X}_{i}$$

Step 3: Calculating the Price Weighted APGR, called pᵢ:

$${p}_{i} = \frac{{g}_{i} * {X}_{i}}{V}$$

Determining the aggregate Price Weighted APGR for the n properties, called TG₀:

$${TG}_{0} = {\sum }_{i = 1}^{n} {p}_{i}$$

TG₀ represents 100 point for HPI at the month of t₀:

HPI₀=100

Wherein the HPI at the month of tᵢ is calculated as below:

$${HPI}_{i} = ( \frac{1 + {TG}_{i}}{1 + {TG}_{i - 1}} ) * {HPI}_{i - 1} * ( 1 + \frac{{TG}_{i - 1}}{12} )$$

Alternatively, this Formula can be written as follows:

$${HPI}_{[ i ]} = ( \frac{1 + {TG}_{[ i ]}}{1 + {TG}_{[ i - 1 ]}} ) * {HPI}_{[ i - 1 ]} * {( 1 + {TG}_{[ i - 1 ]} )}^{\frac{1}{12}}$$

In the above method, the selection criteria may be that the real estate sales prices are further comprised of:

at least 30 or more real estate sales prices;
real estate sales prices in which the previous sale of an individual property was at least 90 days earlier;
real estate sales prices of any individual properties which do not include manufactured or mobile home sales; and
real estate sales prices which do not include: share transfers, sales of leases, transfers between related parties, distress sales, sales of part-interest, trade sales and foreclosures.

Further, in the above method the data may be selected from one or more of the types of individual properties from a group comprising: single houses, strata properties, commercial properties, etc.

In an embodiment of the present invention, there is provided a method for automated generation of a real estate active index, HAI, for a month using a computer system having a server computer coupled to a network and a local data storage device coupled to the server computer, wherein the server computer is configured to receive and store from external sources real estate sales prices of individual properties, n, within selected criteria and in a specific geographical area, wherein X is the real estate sales price in the specified period of time at date A and Y is the previous real estate sales price at date B, and the APGR and weighted APGR for each individual property is determined as follows:

Step 1: Calculate the sum of the sale prices for all n properties, called T₀.

$${T}_{0} = {\sum }_{i = 1}^{{n}_{0}} {p}_{i}$$

and total number of sales is no.
Here n₀ is called n-value at time t₀, while T₀ is called t-value at time t₀.

Step 2: Calculate the number of the total business days in the month, and let's assume there were total d₀ business days in this month. Average working days per month is set up 21 (or 252 days divided by 12 months), d-value is calculated: 21/d₀.
Here it is called d-value at time t₀.

Step 3: set up c-value as the geometric mean of n-value, t-value and d-value, or

$${c}_{0} = \sqrt[3]{{n}_{0} * {t}_{0} * {d}_{0}}$$

Step 4: Set up HAI at the month of t₀=100 (January 2017 HAI: 100 points)

HAI₀=100

At t₁, there were n₁ properties of sales meeting the criteria as stated in III. Criteria of Selection, with sold prices as pᵢ (here i is from 1 to n₁), and there is total d₁ of business days in this month. Similarly, its n-value, t-value, and d-value are calculated at time t₁ as follows:

Step 1: Calculate the sum of the sale prices for all n properties, called T₁.

$${T}_{1} = {\sum }_{i = 1}^{{n}_{1}} {p}_{i}$$

and total number of sales is n₁
At time t₁, t-value=T₁, n-value=n₁

Step 2: d-value is calculated as 21/d₁ at the month of

Step 3: c-value is calculated as

$${c}_{1} = \sqrt[3]{{n}_{1} * {t}_{1} * {d}_{1}}$$

Step 4: The Active Index is calculated as below:

$${HAI}_{1} = \frac{{c}_{1}}{{c}_{0}} * {HAI}_{0}$$

In the above method, the selection criteria may be that the real estate sales prices are further comprised of:

at least 30 or more real estate sales prices;
real estate sales prices of any individual properties which do not include manufactured or mobile home sales; and
real estate sales prices which do not include: share transfers, sales of leases, transfers between related parties, distress sales, sales of part-interest, trade sales and foreclosures.

In the above method, the data may be selected from one or more of the types of individual properties from a group comprising: single houses, condominiums, apartments, multifamily homes, duplexes, agricultural farms, offices, eateries, entertainment venues, sports venues, recreation venues, hotels, motels, bed & breakfasts, stores, shopping centers, strip malls, service stations, manufacturing facilities, warehouses, storage facilities, buildings under construction.

### BRIEF DESCRIPTION OF THE FIGURES

These and other aspects of the present invention will be apparent from the brief description of the drawings and the following detailed description in which:

FIG. 1 is a chart of a real estate price index relative to time in months.

### DETAILED DESCRIPTION OF THE INVENTION

The present invention relates to real estate indices for price and activity of real estate. The Real Estate Price Index (“HPI”), and Real Estate Active Index (“HAI”), may be further divided into indices classified by Residential and Commercial, and segmented by geographical areas and property types. The Real Estate Indices of the present invention apply a quantitative methodology or algorithm in direct calculations based on limited kinds of variables of sales data including sold prices, sold dates, numbers of sales and volumes of sales, rather than current complicated models requiring many variables and assumptions for inputs.

For Real Estate Index modeling, the variables cannot be inclusive and the relationship in the equations between the variables and functions presumed as linear or polynomial cannot be justified. Real estate markets are simply driven by the balance of supplies and demands with a number of factors such as emigrations, job relocations, family reasons, economic and business condition changes, investments, personal reasons, for instances, and the decisions-makings for property buyers and sellers are very complicated and sometimes even irrational. The variables or factors that typically are included in traditional modeling are obviously insufficient for the model's inputs, while other variables or factors which are not related to the property attributes and also difficult to be quantified, are increasingly playing important roles in the process of real estate buy and sell decision-making.

Having observed and acknowledged these factors, the present invention is based on the real estate market being driven by the supply-demand mechanism, the outcome of which is reflected in the above mentioned sales data, and the Real Estate Indices of the present invention are calculated by directly applying quantitative methodologies, described below, using sales data in the segmented markets.

### I. Source of Data

All data are actual and real, obtained from different sources.

### II. Series of Real Estate Indices

### Series I: Real Estate Price Index (“HPI”), Subtitled by

i. HPI Residential, segmented by
   a. Geographical areas or jurisdictions such as provinces, areas, or cities;
   b. Property types such as all types of residential properties, single houses, strata properties,
ii. HPI Commercial, segmented by
   a. Geographical areas or jurisdictions such as provinces, areas, or cities;
   b. Commercial real estates can also further segmented into different usages types such as agricultural farms, offices, industrials, etc.

### Series II: Real Estate Active Index (“HAI”), Similarly Subtitled by

i. HAI Residential, segmented by
   a. Geographical areas or jurisdictions such as provinces, areas, or cities;
   b. Property types such as single Real Estates, condos/apartments, multifamily, etc.
ii. HAI Commercial, segmented by
   a. Geographical areas or jurisdictions such as provinces, areas, or cities;
   b. Commercial real estate can also further segmented into different usages types such as agricultural farms, offices, industrials, etc.

### III. Criteria of Selection

For calculating series of Real Estate Price Indices (HPIs), the following criteria shall be followed:
i. Only a property that has a qualified sales transaction, which shall exclude non arms-length deal, transfer between related parties, distress sale, sale of part-interest, trade and foreclosure, shares transfers, sales of leases, in the current month is included in calculating that month's indices;
ii. Sales of manufactured homes or mobile homes are not included;
iii. At any given market segment, the number of sales transactions must be more than 30 in order to calculate a valid HPIs;
iv. If the time period between the current qualified sale and the previous qualified sale for a property is less than 90 days, that property is not included.
v. In order to eliminate extreme cases, in the calculation of Annualized Price Growth Rate (APGR) between the two qualified sales shall be capped (recommended to be capped between +100% and −100%) for a qualified sale transaction;
vi. Assuming APGRs for a market segment within the same property type are normally distributed, it is recommended to achieve over 99% Confidential Level, z-value=3 shall be used to further filter the samples. In other words, a qualified transaction with its APGR which falls beyond [μ±3σ] shall not be included in the calculation of HPIs.

For calculating series of Real Estate Active Indices (HAIs), the following criteria are recommended:
i. Only a property that has a qualified sales transaction, which shall exclude non arms-length deal, transfer between related parties, distress sale, sale of part-interest, trade and foreclosure, shares transfers, sales of leases, in the current month is included in calculating that month's indices;
ii. Sales of manufactured homes or mobile homes are not included;
iii. At any given market segment, the number of sales transactions must be more than 30 in order to calculate a valid HAIs;

### IV. Quantitative Methodology

The invented quantitative methodology is described as below.

### Series I: Real Estate Price Index (“HPI”)

For the purposes of this example, January 2017 has been chosen and is defined as the month of to with all indice base value of 100.

At t₀, there were n properties of sales meeting the criteria as stated in III. Criteria of Selection, as below:

### Property 1:

Property 1 had a sale in January 2017 with a sale price of X₁ dollars at the date of A₁ (for example, 2017-01-05) in that month, and its previous sale price of Y₁ at the date of B₁.

Step 1: Calculate its Annualized Price Growth Rate (“APGR”) called gᵢ.

$${g}_{1} = {( \frac{{X}_{1}}{{Y}_{1}} )}^{\frac{365}{{A}_{1} - {B}_{1}}} - 1$$

Step 2: Calculate the sum of the sold prices for all above n properties, called V.

$$V = {\sum }_{i = 1}^{n} {X}_{i}$$

Step 3: Calculate the Price Weighted APGR, called p₁.

$${p}_{1} = \frac{{g}_{1} * {X}_{1}}{V}$$

Repeat the above steps for all above n properties, for the i^{th} property, its gᵢ and pᵢ are calculate as below:

$${g}_{i} = {( \frac{{X}_{i}}{{Y}_{i}} )}^{\frac{365}{{A}_{i} - {B}_{i}}} - 1 , {p}_{i} = \frac{{g}_{i} * {X}_{i}}{V}$$

So the aggregate Price Weighted APGR for the n properties is calculated as below, called TG₀:

$${TG}_{0} = {\sum }_{i = 1}^{n} {p}_{i}$$

Here, TG₀ represents 100 point for HPI at the month of to (HPI at January 2017: 100), or

HPI₀=100

At the month of t₁ (i.e., February 2017), there are m properties which meet the criteria as stated in III Criteria of Selection, and the aggregate Price Weighted APGR for the m properties, in the same way, is calculated as below:

$${TG}_{1} = {\sum }_{i = 1}^{m} {p}_{i}$$

The HPI is calculated for the month of t₁ as below:

$${HPI}_{1} = ( \frac{1 + {TG}_{1}}{1 + {TG}_{0}} ) * {HPI}_{0} * ( 1 + \frac{{TG}_{0}}{12} )$$

Similarly, HPI at the month of tᵢ is calculated as below:

$${HPI}_{i} = ( \frac{1 + {TG}_{i}}{1 + {TG}_{i - 1}} ) * {HPI}_{i - 1} * ( 1 + \frac{{TG}_{i - 1}}{12} )$$

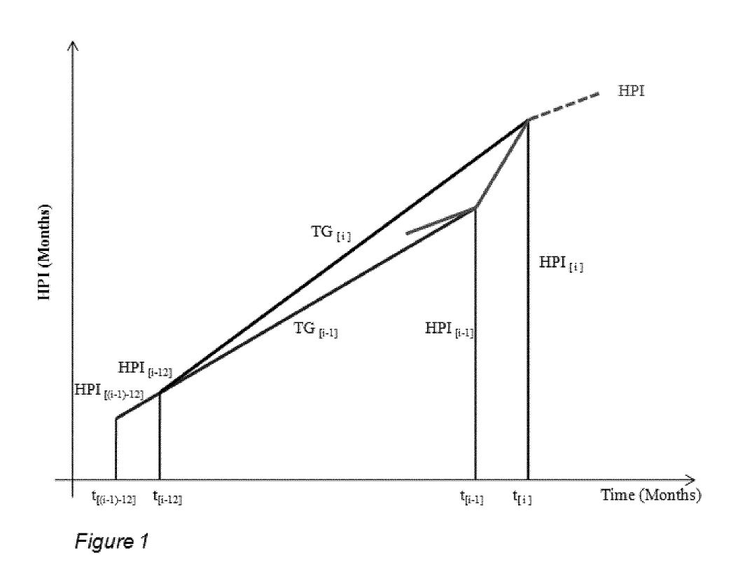

The above formula is called “Real Estate Price Index Formula” of the present invention, which is derived as illustrated in FIG. 1.

Referring to FIG. 1, at the month of t_{[i-1]}, the index is HPI_{[i-1]} and the price-weighted annualized growth rate is t_{[i-1]}, therefore,

HPI_{[i-1]}=HPI_{[(i-1)-12]}*TG_{[i-1]}) (F-1)

Here, HPI_{[(i-1)-12]} is the index at the month of t_{[(i-1)-12]} (or one year ago), so

$${HPI}_{[ ( i - 1 ) - 12 ]} = \frac{{HPI}_{[ i - 1 ]}}{( 1 + {TG}_{[ i - 1 ]} )} \qquad ( F \text{-} 2 )$$

At the month of t_{[i-2]} (11 months ago), given the price-weighted annualized growth rate is TG_{[i-1]}, so

$${HPI}_{[ i - 12 ]} = {HPI}_{[ ( i - 1 ) - 12 ]} * ( 1 + \frac{{TG}_{[ i - 1 ]}}{12} ) \qquad ( F \text{-} 3 )$$

by combining the above two equations (F-2 and F-3), we get

$${HPI}_{[ i - 12 ]} = \frac{{HPI}_{[ i - 1 ]}}{( 1 + {TG}_{[ i - 1 ]} )} * ( 1 + \frac{{TG}_{[ i - 1 ]}}{12} ) \qquad ( F \text{-} 4 )$$

At the month of t_{[i]} (the current month), and the price-weighted annualized growth rate is TG_{[i]}, therefore

HPI_{[i]}=HPI_{[i-12]}*(1+TG_{[i]}) (F-5)

Replacing HPI_{[i-12]} by using F-4, we obtain Real Estate Price Index Formula of the present invention as below:

$${HPI}_{[ i ]} = ( \frac{1 + {TG}_{[ i ]}}{1 + {TG}_{[ i - 1 ]}} ) * {HPI}_{[ i - 1 ]} * ( 1 + \frac{{TG}_{[ i - 1 ]}}{12} )$$

Alternatively, this Formula can be written as follows:

$${HPI}_{[ i ]} = ( \frac{1 + {TG}_{[ i ]}}{1 + {TG}_{[ i - 1 ]}} ) * {HPI}_{[ i - 1 ]} * {( 1 + {TG}_{[ i - 1 ]} )}^{\frac{1}{12}}$$

### Example I

At the month of t₀ (January 2017), the following qualified sales are recorded:

| t = 0 (January 2017) | Current Sale | | Previous Sale | | | |
|---|---|---|---|---|---|---|
| Property | Sold Date | Sold Price | Sold Date | Sold Price | APGR(%) | Price Weighted APGR |
| A | 2017 Jan. 8 | 500,000 | 2016 Apr. 20 | 450,000 | 15.75% | 0.0342 |
| B | 2017 Jan. 25 | 300,000 | 2015 Nov. 11 | 230,000 | 24.60% | 0.0321 |
| C | 2017 Jan. 10 | 600,000 | 2015 Dec. 12 | 520,000 | 14.14% | 0.0369 |
| D | 2017 Jan. 3 | 900,000 | 2014 Oct. 2 | 700,000 | 11.78% | 0.0461 |
| Total | V = | 2,300,000 | | | TG₀ = | 14.93% |

At the month of t₀ (January 2017), the Real Estate Price Index is set up as

HPI_{[0]}=100

At the month of t₁ (February 2017), the following sales are recorded:

| t = 1 (February 2017) | Current Sale | | Previous Sale | | | |
|---|---|---|---|---|---|---|
| Property | Sold Date | Sold Price | Sold Date | Sold Price | APGR(%) | Price Weighted APGR |
| E | 2017 Feb. 2 | 400,000 | 2016 Jan. 20 | 350,000 | 13.72% | 0.0323 |
| F | 2017 Feb. 15 | 700,000 | 2015 Jun. 6 | 550,000 | 15.25% | 0.0628 |
| G | 2017 Feb. 27 | 600,000 | 2013 Jan. 20 | 300,000 | 18.39% | 0.0649 |
| Total | V = | 1,700,000 | | | TG₀ = | 16.00% |

At the month of t₁ (February 2017), the Real Estate Price Index of the present invention is calculated:

$${HPI}_{[ 1 ]} = ( \frac{1 + {TG}_{1}}{1 + {TG}_{0}} ) * {HPI}_{0} * ( 1 + \frac{{TG}_{0}}{12} ) = ( \frac{1 + 16.00 \%}{1 + 14.93 \%} ) * 100 * ( 1 + \frac{14.93 \%}{12} ) = 102.19$$

### Series II: Real Estate Active Index (“HAI”)

January 2017 is defined as the month of t₀, with all indice base value of 100.

At t₀, there were n₀ properties of sales meeting the criteria as stated in III. Criteria of Selection, with sold prices as pᵢ (here i is from 1 to n₀):

Step 1: Calculate the sum of the sale prices for all n properties, called T₀.

$${T}_{0} = {\sum }_{i = 1}^{{n}_{0}} {p}_{i}$$

and total number of sales is n₀.
Here n₀ is called n-value at time t₀, while T₀ is called t-value at time t₀.

Step 2: Calculate the number of the total business days in the month, and let's assume there were total d₀ business days in this month. Average working days per month is set up 21 (or 252 days divided by 12 months), d-value is calculated: 21/d₀.
Here it is called d-value at time t₀.

Step 3: set up c-value as the geometric mean of n-value, t-value and d-value, or

$${c}_{0} = \sqrt[3]{{n}_{0} * {t}_{0} * {d}_{0}}$$

Step 4: Set up HAI at the month of t₀=100 (January 2017 HAI: 100 points)

HAI₀=100

At t₁, there were n₁ properties of sales meeting the criteria as stated in III. Criteria of Selection, with sold prices as pᵢ (here i is from 1 to n₁), and there is total d₁ of business days in this month. Similarly, its n-value, t-value, and d-value are calculated at time t₁ as follows:

Step 1: Calculate the sum of the sale prices for all n properties, called T₁.

$${T}_{1} = {\sum }_{i = 1}^{{n}_{1}} {p}_{i}$$

and total number of sales is n₁
At time t₁, t-value=T₁, n-value=n₁

Step 2: d-value is calculated as 21/d1 at the month of t₁.

Step 3: c-value is calculated as

$${c}_{1} = \sqrt[3]{{n}_{1} * {t}_{1} * {d}_{1}}$$

Step 4: The Active Index is calculated as below:

$${HAI}_{1} = \frac{{c}_{1}}{{c}_{0}} * {HAI}_{0}$$

Similarly, at the i^{th} month, HAI is calculated as below:

$${HAI}_{i} = \frac{{c}_{i}}{{c}_{i - 1}} * {HAI}_{i - 1}$$

The above formula is called “Real Estate Active Index Formula” of the present invention.

### Example II

| | | | | No of |
|---|---|---|---|---|
| | | Total | | business |
| | | number | Total sales | day during |
| Month | Property | of sales | volume (S) | the month |
| t = 0 (January | A, B, C, . . . | 3,000 | 1,800,000,000 | 22 |
| 2017) | | | | |
| t = 1 (February | E, F, G, . . . | 2,800 | 1,708,000,000 | 20 |
| 2017) | | | | |

At the month of t₀ (January 2017), Real Estate Active Index is set up as

HAI_{[O]}=100

Here

$${c}_{0} = \sqrt[3]{{n}_{0} * {t}_{0} * {d}_{0}} = \sqrt[3]{3 , 000 * 1 , 800 , 000 , 000 * 21 / 22} = 17818.28$$

$${c}_{1} = \sqrt[3]{{n}_{1} * {t}_{1} * {d}_{1}} = \sqrt[3]{2 , 800 * 1 , 708 , 000 , 000 * 21 / 20} = 17124.26$$

At the month of t₁ (February 2017), Real Estate Active Index is calculated:

$${HAI}_{1} = \frac{{c}_{1}}{{c}_{0}} * {HAI}_{0} = \frac{17124.26}{17818.28} * 100 = 96.11$$

The above are the key quantitative methodologies for Real Estate Indices calculations.

While embodiments of the invention have been described in the detailed description, the scope of the claims should not be limited by the preferred embodiments set forth in the examples, but should be given the broadest interpretation consistent with the description as a whole.

What is claimed is:

1. A method for automated generation of a real estate price index, for a specified period of time using a computer system having a server computer coupled to a network and a local data storage device coupled to the server computer, wherein the server computer is configured to receive and store from external sources real estate sales prices of individual properties, within selected criteria and in a specific geographical area,
wherein a price weighted annualized price growth rate is calculated based on the annualized price growth rate multiplied by an individual property price divided by the sum of the sold prices,
wherein an aggregated price weighted annualized price growth rate is calculated for a beginning of the specified period of time based on the price weighted annualized price growth rate of all the individual properties,
wherein an aggregated price weighted annualized price growth rate is calculated for an end of the specified period of time based on the price weighted annualized price growth rate of all the individual properties,
and wherein the real estate price index is the ratio of the aggregated price weighted annualized price growth rate from the beginning of the specified period of time to the aggregated price weighted annualized price growth rate from the end of the specified period of time.

2. A method for automated generation of a real estate active index, for a specified period of time using a computer system having a server computer coupled to a network and a local data storage device coupled to the server computer, wherein the server computer is configured to receive and store from external sources real estate sales prices of individual properties, within selected criteria and in a specific geographical area,
wherein the sum of the sale prices for all the individual properties is calculated at the beginning of the specified period of time and at the end of the specified period of time;
and the Golden Ratio is applied to combine the number of properties at the beginning and the end of the specified period of time with the sum of the sale prices at the beginning and the end of the specified period of time adjusted by the number of business days.

3. A method for automated generation of a real estate price index, HPI, for a specified period of time using a computer system having a server computer coupled to a network and a local data storage device coupled to the server computer, wherein the server computer is configured to receive and store from external sources real estate sales prices of individual properties, n, within selected criteria and in a specific geographical area, wherein X is the real estate sales price in the specified period of time at date A and Y is the previous real estate sales price at date B, and the APGR and weighted APGR for each individual property is determined as follows:
Step 1: Calculating the Annualized Price Growth Rate, called gᵢ:
$${g}_{i} = {( \frac{{X}_{i}}{{Y}_{i}} )}^{\frac{365}{{A}_{i} - {B}_{i}}} - 1$$
Step 2: Calculating the sum of the sold prices for all above n properties, called V.
$$V = {\sum }_{i = 1}^{n} {X}_{i}$$
Step 3: Calculating the Price Weighted APGR, called pᵢ:
$${p}_{i} = \frac{{g}_{i} * {X}_{i}}{V}$$
Determining the aggregate Price Weighted APGR for the n properties, called TG₀:
$${TG}_{0} = {\sum }_{i = 1}^{n} {p}_{i}$$
TG₀ represents 100 point for HPI at the month of t₀:
HPI₀=100
Wherein the HPI at the month of tᵢ is calculated as below:
$${HPI}_{i} = ( \frac{1 + {TG}_{i}}{1 + {TG}_{i - 1}} ) * {HPI}_{i - 1} * ( 1 + \frac{{TG}_{i - 1}}{12} )$$
Alternatively, this Formula can be written as follows:
$${HPI}_{[ i ]} = ( \frac{1 + {TG}_{[ i ]}}{1 + {TG}_{[ i - 1 ]}} ) * {HPI}_{[ i - 1 ]} * {( 1 + {TG}_{[ i - 1 ]} )}^{\frac{1}{12}}$$

4. The method of claim 3 in which the selection criteria are that the real estate sales prices are further comprised of:
at least 30 or more real estate sales prices;
real estate sales prices in which the previous sale of an individual property was at least 90 days earlier;
real estate sales prices of any individual properties which do not include manufactured or mobile home sales; and
real estate sales prices which do not include: share transfers, sales of leases, transfers between related parties, distress sales, sales of part-interest, trade sales and foreclosures.

5. The method of claim 4 in which the data is selected from one or more of the types of individual properties from a group comprising: single houses, strata properties, commercial properties.

6. A method for automated generation of a real estate active index, HAI, for a month using a computer system having a server computer coupled to a network and a local data storage device coupled to the server computer, wherein the server computer is configured to receive and store from external sources real estate sales prices of individual properties, n, within selection criteria and in a specific geographical area, wherein X is the real estate sales price in the specified period of time at date A and Y is the previous real estate sales price at date B, and the APGR and weighted APGR for each individual property is determined as follows:
Step 1: Calculate the sum of the sale prices for all n properties, called T₀.
$${T}_{0} = {\sum }_{i = 1}^{{n}_{0}} {p}_{i}$$
and total number of sales is n₀.
Here n₀ is called n-value at time t₀, while T₀ is called t-value at time t₀.
Step 2: Calculate the number of the total business days in the month, and let's assume there were total d₀ business days in this month. Average working days per month is set up 21 (or 252 days divided by 12 months), d-value is calculated: 21/d₀.
Here it is called d-value at time to.
Step 3: set up c-value as the geometric mean of n-value, t-value and d-value, or
$${c}_{0} = \sqrt[3]{{n}_{0} * {t}_{0} * {d}_{0}}$$
Step 4: Set up HAI at the month of t₀=100 (January 2017 HAI: 100 points)
HAI₀=100
At t₁, there were n₁ properties of sales meeting the selection criteria of a qualified sales transaction, with sold prices as pᵢ (here i is from 1 to n₁), and there is total d₁ of business days in this month and its n-value, t-value, and d-value are calculated at time t₁ as follows:
Step 1: Calculate the sum of the sale prices for all n properties, called T₁.
$${T}_{1} = {\sum }_{i = 1}^{{n}_{1}} {p}_{i}$$
and total number of sales is n₁
At time t₁, t-value=T₁, n-value=n₁
Step 2: d-value is calculated as 21/d₁ at the month of t₁.
Step 3: c-value is calculated as
$${c}_{1} = \sqrt[3]{{n}_{1} * {t}_{1} * {d}_{1}}$$
Step 4: The Active Index is calculated as below:
$${HAI}_{1} = \frac{{c}_{1}}{{c}_{0}} * {HAI}_{0}$$

7. The method of claim 6, in which the selection criteria are that the real estate sales prices are further comprised of:
at least 30 or more real estate sales prices;
real estate sales prices of any individual properties which do not include manufactured or mobile home sales; and
real estate sales prices which do not include: share transfers, sales of leases, transfers between related parties, distress sales, sales of part-interest, trade sales and foreclosures.

8. The method of claim 7, in which the data is selected from one or more of the types of individual properties from a group comprising: single houses, condominiums, apartments, multifamily homes, duplexes, agricultural farms, offices, eateries, entertainment venues, sports venues, recreation venues, hotels, motels, bed & breakfasts, stores, shopping centers, strip malls, service stations, manufacturing facilities, warehouses, storage facilities, buildings under construction.
